(19) United States
(12) Patent Application Publication
(10) Pub. No.: US 2025/0139545 A1
(43) Pub. Date: May 1, 2025

(54) INFORMATION PROCESSING APPARATUS, HYDROGEN PRODUCTION SYSTEM, POWER SUPPLY SYSTEM, OPERATION PLAN CREATION METHOD, AND COMPUTER PROGRAM

(71) Applicants: ENEOS Corporation, Chiyoda-ku Tokyo (JP); NATIONAL INSTITUTE OF ADVANCED INDUSTRIAL SCIENCE AND TECHNOLOGY, Chiyoda-ku Tokyo (JP)

(72) Inventors: Kosuke HARADA, Chiyoda-ku, Tokyo (JP); Hirofumi TAKAMI, Chiyoda-ku, Tokyo (JP); Ichiro OKUMO, Chiyoda-ku, Tokyo (JP); Kazuki UEHARA, Chiyoda-ku, Tokyo (JP); Hirokazu KOJIMA, Koriyama-shi, Fukushima (JP); Hiroshi KIKUSATO, Koriyama-shi, Fukushima (JP); Takashi OOZEKI, Koriyama-shi, Fukushima (JP); Hirohide FURUTANI, Koriyama-shi, Fukushima (JP)

(73) Assignees: ENEOS Corporation, Chiyoda-ku Tokyo (JP); NATIONAL INSTITUTE OF ADVANCED INDUSTRIAL SCIENCE AND TECHNOLOGY, Chiyoda-ku Tokyo (JP)

(21) Appl. No.: 18/692,701

(22) PCT Filed: Aug. 15, 2022
(86) PCT No.: PCT/JP2022/030885

§ 371 Date: Mar. 15, 2024

(30) Foreign Application Priority Data
Sep. 16, 2021 (JP) 2021-151052

(51) Int. Cl. G06Q 10/0631; G06Q 50/04

(52) U.S. Cl. CPC G06Q 10/06313; G06Q 50/04

(57) ABSTRACT

A hydrogen production system includes a hydrogen production facility and a management server. The management server includes an operation plan creation unit and an operation plan output unit. The operation plan creation unit creates an operation plan for the hydrogen production facility. The operation plan output unit outputs data including the operation plan created by the operation plan creation unit. The operation plan creation unit creates an operation plan for the hydrogen production facility based on an amount of energy consumed by the hydrogen production facility and a degradation loss of the hydrogen production facility.

### TECHNICAL FIELD

The present disclosure relates to a data processing technology, and specifically relates to an information processing apparatus, a hydrogen production system, a power supply system, an operation plan creation method, and a computer program.

### BACKGROUND ART

Hydrogen production facilities that produce hydrogen by electrolyzing water and hydrogen production facilities that produce hydrogen by reforming city gas are known (see, for example, Patent Literature 1).

### PRIOR ART LITERATURE

### Patent Literature

Patent Literature 1: JP2021-046600 A

### SUMMARY OF INVENTION

### Technical Problem

Conventionally, an operation plan for a hydrogen production facility has been created according to hydrogen demand for each time and cost of energy (for example, electric power) to be used. In the hydrogen production facility, a deterioration rate varies depending on a load factor (for example, a ratio of an actual hydrogen production amount to a rated hydrogen production amount), but the load factor is not considered in the conventional operation plan creation method. Thus, in the conventional operation plan creation method, there is a possibility of performing operation with a large economic loss as a result.

The present disclosure has been made in view of such a circumstance, and one of the objects of the present disclosure is to provide a technology for supporting creation of an efficient operation plan of a hydrogen production facility.

### Solution to Problem

To solve the above problem, an information processing apparatus according to an aspect of the present disclosure includes a processor. The processor executes a first step of creating an operation plan for a hydrogen production facility based on an amount of energy consumed by the hydrogen production facility and a degradation loss of the hydrogen production facility, and a second step of outputting data including the operation plan created in the first step.

Another aspect of the present disclosure is a hydrogen production system. The hydrogen production system includes a hydrogen production facility and an information processing apparatus. The information processing apparatus executes a first step of creating an operation plan for a hydrogen production facility based on an amount of energy consumed by the hydrogen production facility and a degradation loss of the hydrogen production facility, and a second step of outputting data including the operation plan created in the first step.

Still another aspect of the present disclosure is a power supply system. The power supply system is a power supply system that supplies power to a power grid using power obtained from a renewable energy power generator that generates power using renewable energy, the power supply system including a power conditioner device that adjusts power generated by the renewable energy power generator, a storage battery capable of storing and discharging at least a part of surplus power that is not supplied to the power grid among power adjusted by the power conditioner device, a hydrogen production facility that produces hydrogen by using at least a part of the surplus power that is not supplied to the power grid among the power adjusted by the power conditioner device, a hydrogen storage facility capable of storing and releasing hydrogen produced by the hydrogen production facility, a fuel cell that generates power using hydrogen released from the hydrogen storage facility, and control means that controls at least an operation of the hydrogen production facility. The control means creates an operation plan for the hydrogen production facility based on an amount of energy consumed by the hydrogen production facility and a degradation loss of the hydrogen production facility, and controls the hydrogen production facility based on the operation plan.

Yet still another aspect of the present disclosure is an operation plan creation method. In this method, a computer executes a first step of creating an operation plan for a hydrogen production facility based on an amount of energy consumed by the hydrogen production facility and a degradation loss of the hydrogen production facility, and a second step of outputting data including the operation plan created in the first step.

Yet still another aspect of the present disclosure is a computer program. This computer program causes a computer to execute a first step of creating an operation plan for a hydrogen production facility based on an amount of energy consumed by the hydrogen production facility and a degradation loss of the hydrogen production facility, and a second step of outputting data including the operation plan created in the first step.

Any combinations of the above-described components and expressions of the present disclosure converted between a recording medium or the like recording a computer program are also effective as aspects of the present disclosure.

### Advantageous Effects of Invention

The technology of the present disclosure can support creation of an efficient operation plan for a hydrogen production facility.

### BRIEF DESCRIPTION OF DRAWINGS

FIG. 1 is a diagram illustrating a configuration of a hydrogen production system of First Example.

FIG. 2 is a diagram illustrating a plurality of constants used in creation of an operation plan.

FIG. 3 is a diagram illustrating a plurality of variables used in creation of an operation plan.

FIG. 4 is a diagram illustrating a method of determining a degradation acceleration rate in First Example.

FIG. 5 is a diagram illustrating estimation results of First Example and Comparative Example.

FIG. 6 is a diagram illustrating estimation results of First Example and Comparative Example.

FIG. 7 is a diagram illustrating a configuration of a power supply system of Second Example.

### DESCRIPTION OF EMBODIMENTS

A subject of an apparatus or method in the present disclosure includes a computer. The functions of the subject of the apparatus or method in the present disclosure is implemented by this computer executing a computer program. The computer includes a processor that operates according to a computer program as a main hardware configuration. The type of the processor is not limited as long as the function can be implemented by executing the computer program. The processor includes one or a plurality of electronic circuits including a semiconductor integrated circuit (IC, LSI, or the like). The computer program is recorded in a non-transitory recording medium such as a computer-readable ROM, an optical disk, or a hard disk drive. The computer program may be stored in advance in a recording medium, or may be supplied to the recording medium via a wide-area communication network including the Internet or the like.

Hereinafter, the technology of the present disclosure will be described with reference to the drawings based on preferred Examples. The Examples are not intended to limit the invention, but are merely examples, and all the features described in Examples and combinations thereof are not necessarily essential to the invention. The same or equivalent components, members, and processing illustrated in the respective drawings are denoted by the same reference numerals, and redundant description will be omitted as appropriate. The scale and shape of each part illustrated in each drawing are set for convenience in order to facilitate the description, and are not limitedly interpreted unless otherwise specified. The terms “first”, “second”, and the like used in the present specification or claims do not represent any order or importance unless otherwise specified, and are intended to distinguish one configuration from another configuration.

### First Example

First, an outline of First Example will be described. AS described above, in the conventional operation plan creation method, there is a possibility of performing operation with a large economic loss as a result.

As a method for avoiding the loss due to the deterioration of the hydrogen production facility, it is conceivable to operate the hydrogen production facility within a range in which the deterioration is considered to be slight by controlling the load factor or the like. However, it has been conventionally difficult to quantitatively handle the magnitude of deterioration of the hydrogen production facility. For example, it has been difficult to express a difference in deterioration rate of the hydrogen production facility within an operable range. In addition, to improve the economic efficiency of the entire system, it is sometimes preferable to operate the hydrogen production facility in a range where deterioration is large, but it is also difficult to cope with such a case.

Thus, in First Example, a technology of creating an operation plan for the hydrogen production facility based on the amount of energy consumed by the hydrogen production facility and the degradation loss of the hydrogen production facility is proposed. This realizes an operation plan for the hydrogen production facility that achieves both suppression of deterioration of the hydrogen production facility and economic efficiency. In First Example, a mathematical programming method is used to create an operation plan for the hydrogen production facility. The mathematical programming is a method of obtaining an explanatory variable that minimizes or maximizes (collectively referred to as “optimize”) an objective function while satisfying a predetermined constraint condition. In a hydrogen production system of First Example, the objective function including the degradation coefficient (degradation acceleration rate) depending on the operating state of the hydrogen production facility is optimized. In other words, the degradation rate of the hydrogen production facility according to the load factor of the hydrogen production facility is expressed as the load factor dependency of the facility depreciation cost, and the objective function having the degradation rate as one element is optimized.

Specifically, in the hydrogen production system of the First Example, processing using the mathematical programming is executed on the objective function to create an operation plan for the hydrogen production facility. In other words, an operation plan for the hydrogen production facility is created using the mathematical programming that optimizes (minimizes in First Example) the objective function. The objective function includes a first term (a first term of an objective function f to be described later) indicating a cost based on the amount of energy consumed by the hydrogen production facility during operation, and a second term (a second term and a third term of the objective function f to be described later) indicating a cost based on the degradation loss of the hydrogen production facility during operation. As a result, an optimal operation plan for the hydrogen production facility is created. It can be said that the operation plan for the hydrogen production facility is a plan in which the time-series electrolytic power, hydrogen production amount, operation amount, or the like of the hydrogen production facility is determined. For example, the operation plan for the hydrogen production facility may include a data group indicating electrolytic power, a hydrogen production amount, an operation amount, or the like for each unit time in a predetermined planning target period.

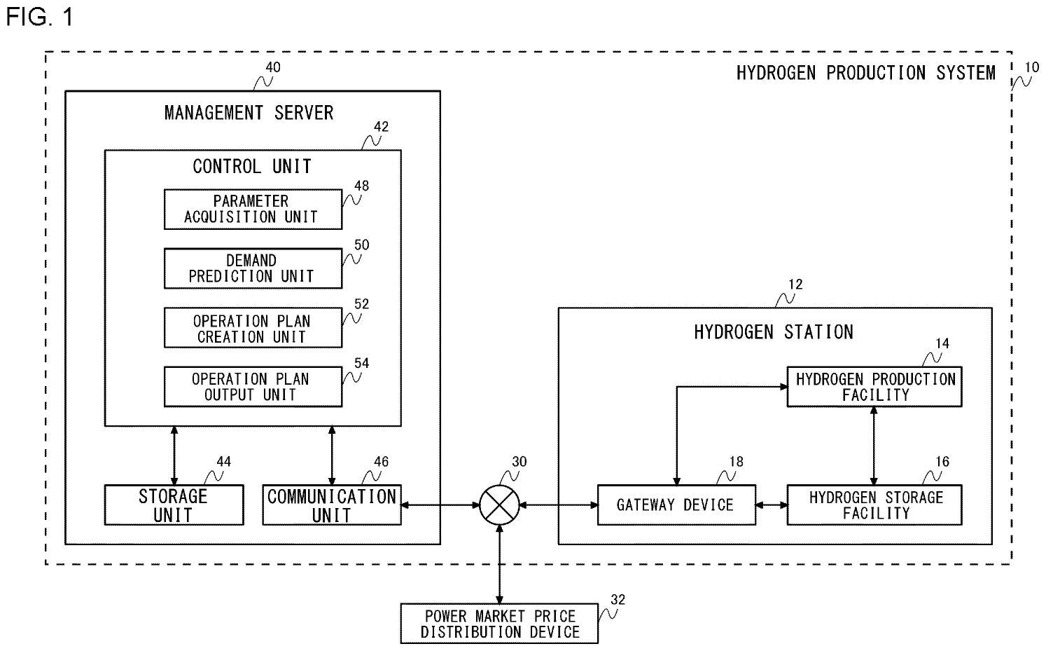

First Example will be described in detail. FIG. 1 illustrates a configuration of a hydrogen production system 10 of First Example. The hydrogen production system 10 includes a hydrogen station 12 and a management server 40. The hydrogen station 12 is a service station that produces, stores, and supplies hydrogen to be used in equipment such as a fuel cell vehicle (hereinafter, also referred to as “FCV”).

The hydrogen station 12 includes a hydrogen production facility 14, a hydrogen storage facility 16, and a gateway device 18. The hydrogen production facility 14 includes a hydrogen generator (also referred to as water electrolysis apparatus or electrolysis tank) that produces hydrogen by electrolyzing water using electric power provided from a power grid. The hydrogen storage facility 16 includes a hydrogen tank that stores hydrogen produced by the hydrogen production facility 14. The gateway device 18 is a device that communicates with a device (in First Example, including the management server 40 to be described later) outside the hydrogen station 12.

The management server 40 is an information processing apparatus that creates an operation plan for the hydrogen production facility 14. The management server 40 may create an operation plan for a plurality of hydrogen stations 12. The gateway device 18 of the hydrogen station 12 and the management server 40 are connected via a communication network 30 including a LAN, a WAN, and the Internet, and constitute an energy management system (EMS). In First Example, the creation of the operation plan for the hydrogen production facility 14 with the management server 40 is provided to the hydrogen station 12 as a cloud service. As a modification, the function of creating an operation plan for the hydrogen production facility 14 (the function of the management server 40 in First Example) may be implemented in a device installed in the hydrogen station 12.

The management server 40 is also connected to a power market price distribution device 32 via the communication network 30. The power market price distribution device 32 provides actual data or predicted data of the power price in the power market to an external device (the management server 40 or the like). The power price in First Example may vary for each unit time (30 minutes in First Example, and is hereinafter also referred to as a “frame”). The unit of the power price is, for example, yen/kWh (kilowatt-hour).

FIG. 1 includes a block diagram illustrating functional blocks of the management server 40. Each block illustrated in the block diagram of the present specification can be realized by a processor (CPU or the like) of a computer, an element including a memory, an electronic circuit, or a mechanical device in terms of hardware, and is realized by a computer program or the like in terms of software, but here, functional blocks realized by cooperation thereof are illustrated. Therefore, it is understood by the skilled person that these functional blocks can be realized in various forms by a combination of hardware and software.

The management server 40 includes a control unit 42, a storage unit 44, and a communication unit 46. The control unit 42 executes various data processing for creating an operation plan for the hydrogen production facility 14. The storage unit 44 includes one or both of a nonvolatile storage area and a volatile storage area, and stores data to be referred to or updated by the control unit 42. The communication unit 46 communicates with an external device in accordance with a predetermined communication protocol. The control unit 42 transmits and receives data to and from the gateway device 18 and the power market price distribution device 32 via the communication unit 46.

The storage unit 44 stores a plurality of constants used in the creation of the operation plan, in other words, a plurality of constants included in the objective function and the constraint condition used in the mathematical programming. The constant can be said to be a parameter whose value does not change in the optimization calculation of the objective function based on the mathematical programming. A value acquired from an external device, a past actual value, a design value, or an assumed value may be set to each constant.

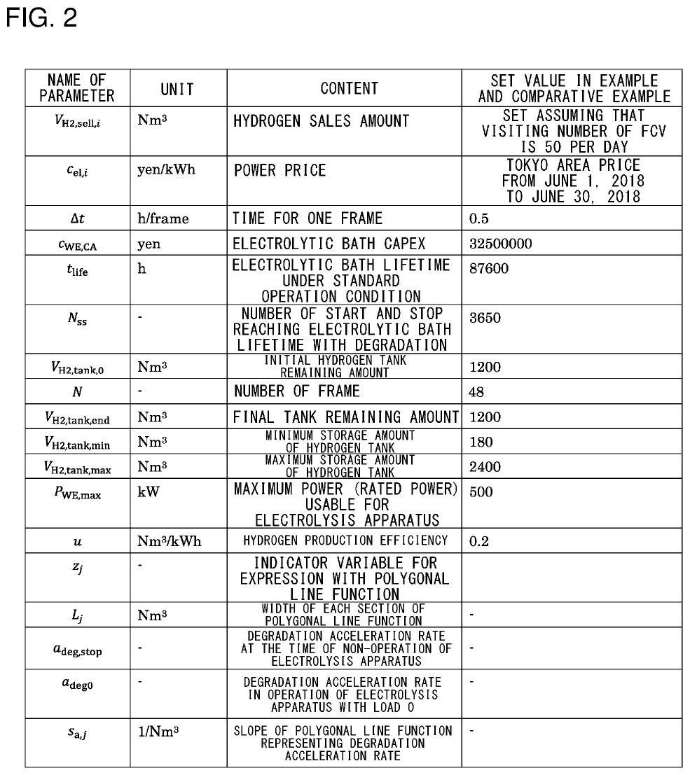

FIG. 2 illustrates a plurality of constants used in the creation of the operation plan. The index i of each constant represents a frame number. One frame is a unit time in creating the operation plan, and one frame in First Example is 30 minutes. In First Example, the target period for creating the operation plan is one day (0:00 to 24:00), and the operation plan is created based on the information obtained at the time of 9:00 of the previous day for each day of the target period. By repeating this processing based on the information for 30 days, an operation plan for 30 days is created. The initial value of the index i is 0, and the end value is 47 (2 frames/time×24 hours−1). Note that, the unit time for creating the operation plan may take any length, and the target period for creating the operation plan may also take any length. As for C_{WE,CA} (electrolytic bath CAPEX), CAPEX stands for capital expenditure, and is an expenditure for capital expenditure. As N (number of frames), 48 (2 frames/hour×24 hours), which is the number of frames per day, is set.

The storage unit 44 also stores a plurality of variables used in the creation of the operation plan, in other words, a plurality of variables included in the objective function and the constraint condition used in the mathematical programming. The variable can be said to be a parameter whose value is optimized by optimization calculation of an objective function based on the mathematical programming.

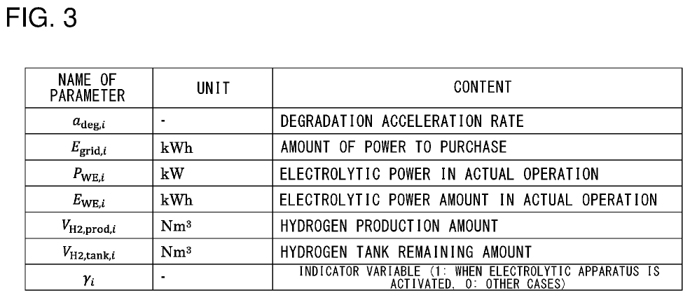

FIG. 3 illustrates the plurality of variables used in the creation of the operation plan. The index i of each variable is the same as the index i of the constant. The electrolytic power P_{WE,i} during actual operation of the hydrogen production facility 14 can also be said to be an operation amount of the hydrogen production facility 14 in each frame.

The degradation acceleration rate a_{deg,i} indicates a ratio between the degree of degradation of the hydrogen production facility 14 at the time of non-operation and the degree of degradation of the hydrogen production facility 14 accompanying the operation of the hydrogen production facility 14 in a certain frame. For example, when the degree of deterioration of the hydrogen production facility 14 at the time of non-operation is “1”, if the degree of deterioration of the hydrogen production facility 14 associated with the operation of the hydrogen production facility 14 in a certain frame is twice that at the time of non-operation, the degradation acceleration rate is “2”. The degradation acceleration rate in each frame is determined according to the hydrogen production amount of the hydrogen production facility 14 in each frame, and specifically determined according to the load factor (for example, the ratio of the actual hydrogen production amount to the rated hydrogen production amount) of the hydrogen production facility 14 in each frame.

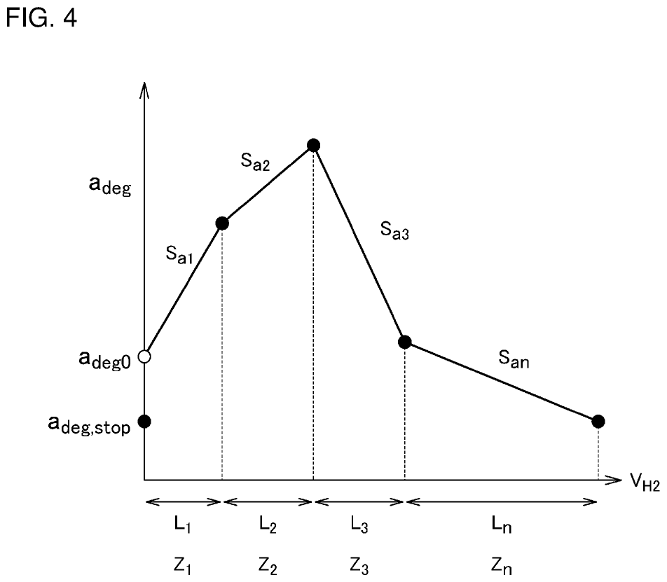

In First Example, the degradation acceleration rate is formulated as a polygonal line function based on the hydrogen production amount. Giving the relationship between the hydrogen production amount and the degradation acceleration rate a_{deg,i} with a polygonal line function makes it possible to describe the relationship as a constraint condition of mixed integer linear programming described later. FIG. 4 illustrates a method for determining the degradation acceleration rate in First Example. In the drawing, the horizontal axis represents the hydrogen production amount in a certain frame, and the vertical axis represents the degradation acceleration rate in the frame. For example, when the hydrogen production amount corresponds to the section L₁, the degradation acceleration rate is a function of the slope Sₐ₁. When the hydrogen production amount corresponds to the section Lₙ, the degradation acceleration rate is a function of the slope Sₐₙ. When the hydrogen production amount corresponds to the section L₃ to the section Lₙ, the degradation acceleration rate decreases as the hydrogen production amount increases. As a modification, the degradation acceleration rate may be formulated as a continuous function based on the hydrogen production amount. The degradation acceleration rate can be appropriately set based on experiments or simulations in accordance with the properties of the electrolytic bath. In addition, the degradation acceleration rate may be formulated as a discontinuous function related to the hydrogen production amount.

The control unit 42 includes a parameter acquisition unit 48, a demand prediction unit 50, an operation plan creation unit 52, and an operation plan output unit 54. A computer program in which the functions of the plurality of functional blocks are implemented may be installed in a storage (the storage unit 44 or the like) of the management server 40. The control unit 42 may be realized by a processor (CPU or the like) of the management server 40. The processor of the management server 40 may perform the functions of the plurality of functional blocks by reading the computer program into the main memory and executing the computer program.

The parameter acquisition unit 48 acquires a value of a parameter (for example, a value of a constant parameter) used in the operation plan creation from an external device and stores the value in the storage unit 44. For example, the parameter acquisition unit 48 acquires data of the power price C_{el,i} (power price for each frame) used when creating the operation plan from the power market price distribution device 32. The parameter acquisition unit 48 may acquire the power price data of the same month of the previous year as the power price data of the period (hereinafter, it is also referred to as “planning target period”) in which the operation plan is created.

The demand prediction unit 50 predicts a hydrogen sales amount V_{H2,sell,i} (also referred to as hydrogen demand amount) for each frame in the planning target period and stores the data in the storage unit 44. The demand prediction unit 50 may predict the hydrogen sales amount in the planning target period based on the past hydrogen sales amount results, increase/decrease tendencies, weather information and traffic information regarding the planning target period, and the like.

The operation plan creation unit 52 creates an operation plan for the hydrogen production facility 14 using a mathematical programming. Expression 1 represents an objective function f in the operation plan creation.

$$f = {\sum }_{i} {c}_{el , i} {E}_{grid , i} + {\sum }_{i} \frac{{c}_{WE , CA}}{{N}_{ss}} {γ}_{i} + {\sum }_{i} {c}_{WE , CA} \frac{Δ t}{{t}_{life}} {a}_{deg , i} \qquad ( Expression 1 )$$

The objective function f is to sum the sum of the power purchase cost and the depreciation cost due to device deterioration over all frames in the planning target period. The first term of the objective function f indicates the power purchase cost for each frame for operating the hydrogen production facility 14, in other words, indicates the cost based on the amount of energy consumed by the hydrogen production facility 14 for each frame. The terms 2 and 3 indicate the cost based on the degradation loss of the hydrogen production facility 14 for each frame due to the operation of the hydrogen production facility 14. Specifically, the term 2 indicates the cost based on the degradation loss associated with the start and stop of the hydrogen production facility 14 for each frame. In First Example, the indicator variable is set to 1 when the electrolytic apparatus is activated, and the indicator variable is set to 0 in other cases. The term 3 indicates the cost based on the degradation loss over time associated with the operation of the hydrogen production facility 14 for each frame.

The third term of the objective function f includes the degradation acceleration rate a_{deg,i} for each frame. In the optimization calculation of the objective function f, the operation plan creation unit 52 sets a function formulated in advance (the polygonal line function of FIG. 4 in First Example) as the degradation acceleration rate a_{deg,i}. As illustrated in FIG. 4, the magnitude of the degradation acceleration rate a_{deg,i} in a certain frame i is determined according to the hydrogen production amount by the hydrogen production facility 14 in the frame i (in other words, the operation amount of the hydrogen production facility 14). For example, when the hydrogen production amount of a certain frame i corresponds to the section L₃ to the section Lₙ and the hydrogen production amount (in other words, the operation amount of the hydrogen production facility 14) is relatively small, the degradation acceleration rate (that is, the degradation loss) of the hydrogen production facility 14 becomes relatively large. On the other hand, when the hydrogen production amount (in other words, the operation amount of the hydrogen production facility 14) is relatively large, the degradation acceleration rate (that is, the degradation loss) of the hydrogen production facility 14 becomes relatively small.

The following Expression 2 to Expression 7 indicate constraint conditions in the operation plan creation.

$${E}_{grid , i} = {E}_{WE , i} = {P}_{WE , i} Δ t \qquad ( Expression 2 )$$

$${V}_{H 2 , prod , i} = u \cdot {E}_{WE , i} \qquad ( Expression 3 )$$

$${V}_{H 2 , tank , i} = {V}_{H 2 , tank , 0} + {\sum }_{j = 0}^{i} ( {V}_{H 2 , prod , j} - {V}_{H 2 , sell , j} ) \qquad ( Expression 4 )$$

$${V}_{H 2 , tank , N - 1} = {V}_{H 2 , tank , end} \qquad ( Expression 5 )$$

$${V}_{H 2 , tank , min} \leq {V}_{H 2 , tank , i} \leq {V}_{H 2 , tank , max} \qquad ( Expression 6 )$$

$$0 \leq {P}_{WE , i} \leq {P}_{WE , max} \qquad ( Expression 7 )$$

Expression 2 indicates a constraint in which the purchased power amount E_{grid,i} from the power grid per frame matches the power consumption amount E_{WE,i} of the hydrogen production facility 14. Expression 3 indicates a constraint on the relationship between a hydrogen production amount V_{H2,prod,i} and the power consumption amount E_{WE,i} of the hydrogen production facility 14. Expressions 4 to 6 indicates constraints on the hydrogen remaining amount in the hydrogen storage facility 16 (hydrogen tank). Expression 7 is a constraint on the electrolytic power P_{WE,i} (in other words, power consumption) of the hydrogen production facility 14.

Expression 4 and Expression 6 define that the hydrogen production amount satisfies the hydrogen sales amount. Expression 4 defines that the tank remaining amount is the sum of an increase due to past hydrogen production and a decrease due to hydrogen supply to the FCV. Expression 6 defines that the tank remaining amount is not below the minimum storage amount and not above the maximum storage mount. The minimum storage amount is, for example, the minimum amount of hydrogen to be stored in order to satisfy the hydrogen sales amount. The maximum storage amount is, for example, the capacity of the hydrogen tank. Alternatively, an amount provided with a margin may be set as the minimum storage amount or the maximum storage amount.

Expression 5 defines that the tank remaining amount (final tank remaining amount) when one operation plan ends (that is, when the index i of the frame number reaches the final value) is set as a specified value. When Expression 5 is not provided, an operation plan is created such that the final tank remaining amount becomes zero when the objective function is optimized. However, when the tank remaining amount becomes zero, hydrogen cannot be supplied to the FCV. Providing Expression 5 makes it possible to create an optimal operation plan while leaving only the specified amount of the final tank remaining amount. In First Example, the final tank remaining amount is half the maximum storage amount of the hydrogen tank.

The operation plan creation unit 52 derives an operation amount of the hydrogen production facility 14 that optimizes the objective function f represented in Expression 1 using a mathematical programming (for example, mixed integer linear programming). Specifically, the operation plan creation unit 52 derives a value of an explanatory variable that minimizes (that is, minimize cost) the objective function f under the constraint conditions indicated in Expression 2 to Expression 7 based on the parameter values stored in the storage unit 44. This explanatory variable includes, for example, E_{grid,i}, γᵢ, a_{deg,i}, P_{WE,i}, E_{WE,i}, V_{H2,prod,i}, and V_{H2,tank,i}. A known technique may be used for solving the explanatory variable by the mathematical programming.

The operation plan creation unit 52 creates data of the operation plan for the hydrogen production facility 14 based on each derived variable value. For example, the operation plan creation unit 52 may create operation plan data including the power purchase amount E_{grid,i} of each frame in the planning target period, the electrolytic power (in other words, the operation amount) P_{WE,i} of the hydrogen production facility 14, and the value of the indicator variable γᵢ.

The operation plan output unit 54 transmits data including the operation plan created by the operation plan creation unit 52 to the hydrogen station 12 (gateway device 18).

An operation of the hydrogen production system 10 having the above configuration will be described. The parameter acquisition unit 48 of the management server 40 acquires values of various parameters necessary for creating an operation plan for the hydrogen production facility 14 from an external device and stores the values in the storage unit 44. The demand prediction unit 50 of the management server 40 predicts the hydrogen sales amount in the planning target period and stores the prediction value in the storage unit 44. The operation plan creation unit 52 of the management server 40 inputs the values of the plurality of parameters stored in the storage unit 44 to the objective function of Expression 1 and the constraint conditions of Expressions 2 to 7, and derives an explanatory variable (power purchase amount or the like) that minimizes the objective function using the mathematical programming. The operation plan creation unit 52 creates an operation plan data based on each variable value derived using the mathematical programming. For example, the management server 40 (information processing apparatus) includes a processor, and the processor executes creation of an operation plan for the hydrogen production facility 14 based on the amount of energy consumed by the hydrogen production facility and the degradation loss of the hydrogen production facility (first step).

The operation plan output unit 54 of the management server 40 transmits the operation plan data to the gateway device 18 of the hydrogen station 12. For example, the processor of the management server 40 outputs data including the operation plan created in the first step (second step). In the hydrogen station 12, the power purchase from the power grid and the operation of the hydrogen production facility 14 are controlled according to the operation plan data transmitted from the management server 40, and hydrogen is produced.

According to the hydrogen production system 10 (management server 40) of First Example, it is possible to create an operation plan for the hydrogen production facility 14 capable of supplying hydrogen satisfying the hydrogen sales amount and an operation plan for the hydrogen production facility 14 in which an economic loss due to facility deterioration is reduced. This makes it possible to improve the overall economic efficiency related to the operation of the hydrogen production facility 14.

Hereinafter, the estimation results with the operation plan creation method of First Example and the operation plan creation method of Comparative Example will be described. In this estimation, an actual contract price in a power wholesale market in Japan (Tokyo area price from Jun. 1, 2018 to Jun. 30, 2018) was used as the power price C_{el,i}. A demand curve was created assuming that the number of FCVs visiting the hydrogen station 12 was 50 per day, and a hydrogen sales amount V_{H2,sell,i} for each frame was set.

Expression 8 represents an objective function of Comparative Example.

$$f = {\sum }_{i} {c}_{el , i} {E}_{grid , i} + {\sum }_{i} \frac{{c}_{WE , CA}}{{N}_{ss}} {γ}_{i} + {\sum }_{i} {c}_{WE , CA} \frac{Δ t}{{t}_{life}} \qquad ( Expression 8 )$$

The first term and the second term of the objective function of Comparative Example are the same as that of the objective function of First Example. On the other hand, the objective function of Comparative Example is different from the objective function of First Example in that the third term is independent of the load factor of the hydrogen production facility 14 (specifically, a_{deg,i}=1). That is, the third term of the objective function of Comparative Example does not include the degradation acceleration rate. Other conditions (constraint conditions, constants, variables, and the like) in Comparative Example are the same as those in First Example.

In each of First Example and Comparative Example, an operation plan for 30 days for the hydrogen production facility 14 was created by repeatedly performing an operation plan for one day based on 30 days of information. Then, the power purchase cost per unit hydrogen production amount (here, 1 Nm³) when the hydrogen production facility 14 was operated according to the operation plan was estimated. The power purchase cost is a value obtained by dividing the sum of the first term of the objective function for 30 days by the sum of the hydrogen production amounts V_{H2,prod,i} for 30 days.

In addition, in each of First Example and Comparative Example, the degradation loss per unit hydrogen production amount was estimated. The degradation loss is a value obtained by dividing the sum of the third term of the objective function for 30 days by the sum of the hydrogen production amounts V_{H2,prod,i} for 30 days. Note that, the degradation loss in each frame of Comparative Example was calculated by obtaining the value of the degradation acceleration rate a_{deg,i} corresponding to the value of the hydrogen production amount V_{H2,prod,i} obtained by the calculation of Comparative Example in the same manner as in First Example and inputting the value a_{deg,i} to the third term of the objective function of First Example.

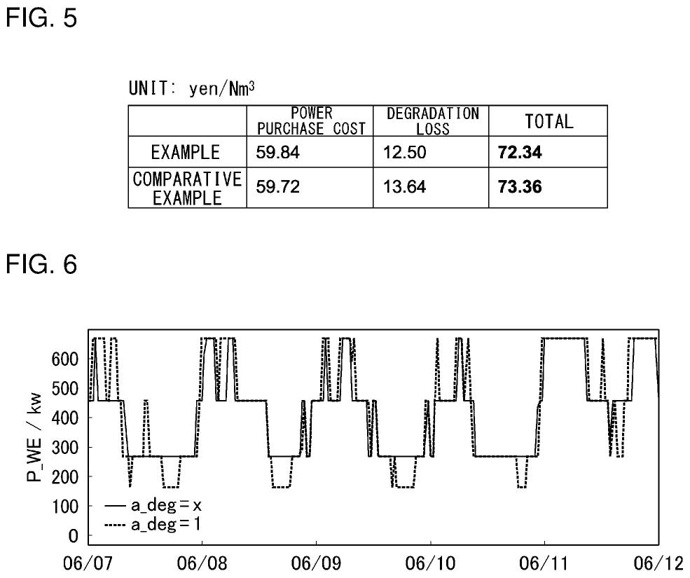

FIGS. 5 and 6 illustrates estimation results of First Example and Comparative Example. FIG. 5 illustrates the power purchase cost and the degradation loss per unit hydrogen production amount for each of First Example and Comparative Example. In the operation plan creation method of First Example, as compared with Comparative Example, the degradation loss can be reduced without almost increasing the power purchase cost, and as a result, the sum of the power purchase cost and the degradation loss related to hydrogen production can be reduced. That is, in the operation plan creation method of First Example, an operation plan having relatively high economic efficiency in the entire system was able to be created.

FIG. 6 illustrates the operation amount (electrolytic power P_{WE,i} during actual operation) of the hydrogen production facility 14 derived in each of First Example and Comparative Example. In the operation plan creation method of First Example (solid line), an operation plan for avoiding operation in a low load region having a relatively high degradation acceleration rate is created. On the other hand, in Comparative Example (broken line), the operation in the low load region increased, and the degradation loss of the hydrogen production facility 14 increased.

The present disclosure has been described above based on First Example. It is to be understood by the skilled person that First Example is an example, various modifications can be made to the combination of each component or each processing process, and such modifications are also within the scope of the present disclosure.

For example, in First Example, the objective function f is formed only of the first term representing the power cost and the second and third terms representing the degradation loss of the facility, but other configurations may be used. For example, when the power cost is always constant, an objective function not including the first term may be used. For example, when the hydrogen sales price varies depending on the time zone, the sum of the product of the hydrogen sales price and the hydrogen production amount for each time may be included in the objective function. In addition, the constraint conditions used in First Example are not necessarily used, and constraint conditions other than the constraint conditions used in First Example may be used. For example, when hydrogen is not produced outside business hours, a constraint condition that the hydrogen production amount outside business hours is 0 may be included.

In addition, for example, in First Example, the hydrogen production facility 14 is provided in the hydrogen station 12, but as a modification, the hydrogen production facility 14 may be provided in a hydrogen supply facility for a fuel cell, chemical synthesis, or the like. The hydrogen production facility 14 may be provided in an energy (electric power, heat, hydrogen, and the like) supply system, and the energy supply system may include a storage battery, a fuel cell, and the like together with the hydrogen production facility 14.

In First Example, the operation plan output unit 54 of the management server 40 transmits the operation plan data to the hydrogen production system 10 (gateway device 18). As a modification, the operation plan output unit 54 may store the operation plan data in a predetermined local or remote storage area. The operation plan output unit 54 may output the operation plan data to a predetermined display device and cause the display device to display the driving plan.

In First Example, the planning target period is one day. However, the planning target period is not limited to this period. When longer-term demand prediction or price prediction information is available, the planning target period may be longer than one day. The planning target period in this case may be, for example, 7 days (2 frames/hour×24 hours×7 days=336 frames). In addition, a shorter operation plan may be created at a higher frequency. For example, a plan for six hours in the future may be created every three hours.

The parameter acquisition unit 48 of the management server 40 may acquire values of parameters for creating the operation plans for a plurality of hydrogen production facilities 14 from an external device. The storage unit 44 of the management server 40 may store the values of the parameters for creating operation plans for the plurality of hydrogen production facilities 14. The plurality of hydrogen production facilities 14 may be intensively installed in one hydrogen station 12 or may be dispersedly installed in a plurality of hydrogen stations 12. The operation plan creation unit 52 of the management server 40 may create the operation plan for each of the plurality of hydrogen production facilities 14 based on the amount of energy consumed by each of the plurality of hydrogen production facilities 14 and the degradation loss of each of the plurality of hydrogen production facilities 14. The operation plan output unit 54 of the management server 40 may transmit data including the operation plan for each of the plurality of hydrogen production facilities 14 to the gateway device 18 of the hydrogen station 12 in which each hydrogen production facility 14 is installed.

Although not mentioned in First Example, in the hydrogen station 12, a device (here, it is referred to as “instruction device”) that instructs the hydrogen production facility 14 to produce hydrogen based on the data including the operation plan transmitted from the hydrogen production facility 14 may be installed. For example, the instruction device may control the operation of the hydrogen production facility 14 according to the electrolytic power P_{WE,i} of the hydrogen production facility 14 of each frame indicated by the operation plan. The gateway device 18 of the hydrogen station 12 may include a function of the instruction device. In addition, the hydrogen production facility 14 may produce hydrogen based on instruction data from the instruction device, and may vary the hydrogen production amount for each frame.

### Second Example

Second Example of the present disclosure will be described focusing on differences from First Example, and description of common points will be appropriately omitted. It goes without saying that the features of Second Example can be freely combined with the features of First Examples and modifications. Among the components of Second Example, components that are the same as or correspond to the components of First Example will be appropriately denoted by the same reference numerals and described.

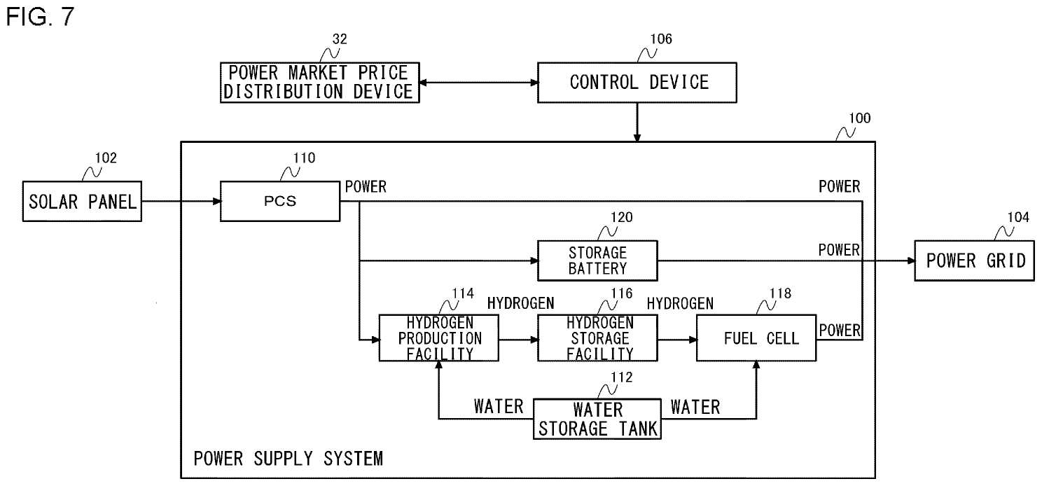

In Second Example, the technical idea described in First Example is applied to a power supply system including a hydrogen production facility. FIG. 7 is a diagram illustrating a configuration of a power supply system 100 of Second Example. The power supply system 100 is a self-sustaining power supply system that supplies power to a power grid 104 using power from a renewable energy power generator that generates power using renewable energy, for example, a solar power generator (solar panel 102) that generates power using sunlight. The power grid 104 is a system owned by a general power transmission and distribution company, and is a system that integrates power generation, transformation, power transmission, and power distribution for supplying power to a power receiving facility of a consumer.

The power supply system 100 includes a power conditioner device 110 (hereinafter, referred to as “PCS 110”), a water storage tank 112, a hydrogen production facility 114, a hydrogen storage facility 116, a fuel cell 118, a storage battery 120, and a control device 106. In the example of FIG. 7, the control device 106 is disposed outside the power supply system 100, but the present disclosure is not limited to this example. The control device 106 may be configured as a part of the power supply system 100.

The solar panel 102 includes a solar cell and constitutes a solar power generator that generates electric power by receiving sunlight at the solar cell and performing photoelectric conversion. Although the solar panel 102 is illustrated in FIG. 7, another power generator may be adopted as long as the power generator generates electric power using renewable energy. For example, a wind power generator that generates electric power from wind power may be adopted. A hydraulic power generator that generates electric power from hydraulic power may also be adopted. A geothermal power generator, a wave power generator, a temperature difference power generator, or a biomass power generator may be adopted. Further, a combination of power generators that generate electric power using these renewable energies may be adopted.

The PCS 110 adjusts the power generated by the solar panel 102. Here, the PCS 110 converts the power from the solar panel 102 into power that can be supplied to the power grid 104.

The water storage tank 112 stores water and supplies the stored water to the hydrogen production facility 114 and the fuel cell 118. In the example of FIG. 7, the water storage tank 112 is disposed inside the power supply system 100, but the present disclosure is not limited to this example. The water storage tank 112 may be provided outside the power supply system 100. As a modification, the power supply system 100 may supply water directly from the outside (for example, a water pipe) to the hydrogen production facility 114 and the fuel cell 118.

The hydrogen production facility 114 corresponds to the hydrogen production facility 14 of First Example. The hydrogen production facility 114 produces hydrogen by using at least a part of surplus power that is not supplied to the power grid 104 among the power adjusted by the PCS 110. Specifically, under the control of the control device 106, the hydrogen production facility 114 produces hydrogen by electrolyzing water supplied from the water storage tank 112 using electric power generated by the solar panel 102 and then adjusted by the PCS 110. In addition, the hydrogen production facility 114 includes a measuring instrument (not illustrated) such as a gas sensor, a pressure gauge, or a flow meter, and data measured by the measuring instrument is output to the control device 106 as a data signal.

The hydrogen storage facility 116 corresponds to the hydrogen storage facility 16 of First Example. As the hydrogen storage facility 116, a known facility capable of storing and releasing hydrogen can be adopted. For example, the hydrogen storage facility 116 includes a hydrogen absorbing alloy excellent in absorbing and releasing hydrogen, and stores and releases hydrogen produced by the hydrogen production facility 114 under the control of the control device 106. In addition, the hydrogen storage facility 116 includes a measuring instrument (not illustrated) such as a gas sensor, a pressure gauge, or a flow meter, and data measured by the measuring instrument is output to the control device 106 as a data signal.

Under the control of the control device 106, the fuel cell 118 generates power using hydrogen discharged from the hydrogen storage facility 116 and generates hot water using water supplied from the water storage tank 112 and exhaust heat. The power generated through the power generation of the fuel cell 118 is supplied to the power grid 104. The fuel cell 118 includes a measuring instrument (not illustrated) such as a gas sensor, a pressure gauge, or a flow meter, and a measuring instrument (not illustrated) that measures a reserved amount of hydrogen, and data measured by the measuring instrument is output to the control device 106 as a data signal.

The storage battery 120 stores at least a part of surplus power not supplied to the power grid 104 in the power adjusted by the PCS 110 and discharges the stored power. Specifically, the storage battery 120 stores the power generated by the solar panel 102 and adjusted by the PCS 110 under the control of the control device 106. The power stored in the storage battery 120 can be supplied to the power grid 104 by being discharged under the control of the control device 106. The storage battery 120 includes a measuring instrument (not illustrated) that measures the storage amount, and data measured by the measuring instrument is output to the control device 106 as a data signal.

The control device 106 is realized as, for example, an energy management system (EMS), and is configured as control means that controls each unit constituting the power supply system 100. The control device 106 includes an arithmetic unit (not illustrated) and a memory (not illustrated), and controls each unit by the arithmetic unit performing arithmetic processing using a program stored in the memory device. For example, the control device 106 performs control on the production amount of hydrogen in the hydrogen production facility 114, the storage amount/release amount of hydrogen in the hydrogen storage facility 116, the power generation amount in the fuel cell 118, the storage amount/discharge amount in the storage battery 120, and the like as control targets based on various types of information obtained from the outside or the inside of the power supply system 100.

The control device 106 is connected to the power market price distribution device 32 via the communication network. The control device 106 has a function of the management server 40 of First Example. For example, like the management server 40 of First Example, the control device 106 may include the parameter acquisition unit 48, the demand prediction unit 50, the operation plan creation unit 52, and the operation plan output unit 54 (not illustrated).

The control device 106 creates, like the management server 40 of First Example, an operation plan for the hydrogen production facility 114 based on the amount of energy consumed by the hydrogen production facility 114 and the degradation loss of the hydrogen production facility 114. In the creation of the operation plan, the configuration described in First Example can be applied. The control device 106 controls the hydrogen production facility 114 based on the created operation plan, like the instruction device of the above-described modification.

According to the power supply system 100 of Second Example, it is possible to create an efficient operation plan for the hydrogen production facility 114 in consideration of the economic loss due to facility deterioration, and it is possible to improve the overall economic efficiency related to the operation of the hydrogen production facility 114 in the power supply system 100.

The present disclosure has been described above based on Second Example. It is to be understood by the skilled person that Second Example is an example, various modifications can be made to the combination of each component or each processing process, and such modifications are also within the scope of the present disclosure.

Any combination of the above-described examples and modifications is also useful as an embodiment of the present disclosure. A new embodiment generated by the combination has the effect of each of the combined examples and modifications. In addition, it is understood by the skilled person that the functions to be performed by the components described in the claims are realized by a single body of each component described in examples and the modifications or by cooperation of the components.

The technology described in the present disclosure can also be expressed as the following items.

### Item 1

An information processing apparatus (40) including a processor (42), wherein
the processor (42) executes:
a first step (52) of creating an operation plan for a hydrogen production facility (14) based on an amount of energy consumed by the hydrogen production facility (14) and a degradation loss of the hydrogen production facility (14); and
a second step (54) of outputting data including the operation plan created in the first step (52).

According to this information processing apparatus, it is possible to create an operation plan for a hydrogen production facility in which the degradation loss of the hydrogen production facility is taken into consideration, and it is possible to improve the overall economic efficiency related to the operation of the hydrogen production facility.

### Item 2

The information processing apparatus (40) according to item 1, wherein
in the first step (52), processing using a mathematical programming on an objective function is executed to create an operation plan for the hydrogen production facility (14), and
the objective function includes a first term indicating a cost based on the amount of energy consumed by the hydrogen production facility (14) and a second term indicating a cost based on the degradation loss of the hydrogen production facility (14).

According to this information processing apparatus, it is possible to create a more efficient operation plan of a hydrogen production facility in which an economic loss due to the degradation loss of the hydrogen production facility is taken into consideration using a mathematical programming.

### Item 3

The information processing apparatus (40) according to item 2, wherein
the first term indicates a cost based on the amount of energy consumed by the hydrogen production facility (14) for each unit time, and
the second term indicates a cost based on the degradation loss of the hydrogen production facility (14) for each unit time.

According to this information processing apparatus, it is possible to obtain an optimum operation amount for each unit time of the hydrogen production facility and create a more useful operation plan.

### Item 4

The information processing apparatus (40) according to item 3, wherein
the second term includes a degradation acceleration rate determined according to a hydrogen production amount of the hydrogen production facility (14) in the unit time.

According to this information processing apparatus, it is possible to appropriately determine the magnitude of the degradation loss of the hydrogen production facility, and it is possible to more accurately derive the operation amount of the hydrogen production facility.

### Item 5

The information processing apparatus (40) according to item 4, wherein
the degradation acceleration rate is configured to be relatively large when the hydrogen production amount of the hydrogen production facility (14) in a certain unit time is relatively small, and to be relatively small when the hydrogen production amount of the hydrogen production facility (14) in a certain unit time is relatively large.

According to this information processing apparatus, it is possible to appropriately determine the magnitude of the degradation loss of the hydrogen production facility, and it is possible to more accurately derive the operation amount of the hydrogen production facility.

### Item 6

The information processing apparatus (40) according to any one of items 1 to 5, wherein
in the first step, an operation plan for each of a plurality of hydrogen production facilities (14) is created based on an amount of energy consumed by each of the plurality of hydrogen production facilities (14) and a degradation loss of each of the plurality of hydrogen production facilities (14).

According to this information processing apparatus, it is possible to collectively create an efficient operation plan for a plurality of hydrogen production facilities.

### Item 7

A hydrogen production system (10) including:
a hydrogen production facility (14); and
an information processing apparatus (40), wherein
the information processing apparatus (40) executes:
a first step of creating an operation plan for the hydrogen production facility (14) based on an amount of energy consumed by the hydrogen production facility (14) and a degradation loss of the hydrogen production facility (14); and
a second step of outputting data including the operation plan created in the first step.

According to this hydrogen production system, it is possible to create an operation plan for a hydrogen production facility in which an economic loss due to the degradation loss of the hydrogen production facility is taken into consideration, and it is possible to improve the overall economic efficiency related to the operation of the hydrogen production facility.

### Item 8

The hydrogen production system (10) according to item 7, further including
an instruction device that instructs the hydrogen production facility (14) to produce hydrogen based on the data including the operation plan output from the information processing apparatus (40).

According to this hydrogen production system, the operation of the hydrogen production facility based on the operation plan can be efficiently realized.

### Item 9

The hydrogen production system (10) according to item 8, wherein
the hydrogen production facility (14) produces hydrogen based on an instruction from the instruction device.

According to this hydrogen production system, the operation of the hydrogen production facility based on the operation plan can be efficiently realized.

### Item 10

A power supply system (100) that supplies power to a power grid (104) using power obtained from a renewable energy power generator (102) that generates power using renewable energy, the power supply system (100) including:
a power conditioner device (110) that adjusts power generated by the renewable energy power generator (102);
a storage battery (120) capable of storing and discharging at least a part of surplus power that is not supplied to the power grid (104) among power adjusted by the power conditioner device (110);
a hydrogen production facility (114) that produces hydrogen by using at least a part of the surplus power that is not supplied to the power grid (104) among the power adjusted by the power conditioner device (110);
a hydrogen storage facility (116) capable of storing and releasing hydrogen produced by the hydrogen production facility (114);
a fuel cell (118) that generates power using hydrogen released from the hydrogen storage facility (116); and
control means (106) that controls at least an operation of the hydrogen production facility (114), wherein
the control means (106) creates an operation plan for the hydrogen production facility (114) based on an amount of energy consumed by the hydrogen production facility (114) and a degradation loss of the hydrogen production facility (114), and controls the hydrogen production facility (114) based on the operation plan.

According to this power supply system, it is possible to create an operation plan for a hydrogen production facility in which the degradation loss of the hydrogen production facility is taken into consideration, and it is possible to improve the overall economic efficiency related to the operation of the hydrogen production facility.

### Item 11

An operation plan creation method, wherein
a computer (40) executes:
a first step (52) of creating an operation plan for a hydrogen production facility (14) based on an amount of energy consumed by the hydrogen production facility (14) and a degradation loss of the hydrogen production facility (14); and
a second step (54) of outputting data including the operation plan created in the first step.

According to this operation plan creation method, it is possible to create an operation plan for a hydrogen production facility in which the degradation loss of the hydrogen production facility is taken into consideration, and it is possible to improve the overall economic efficiency related to the operation of the hydrogen production facility.

### Item 12

A computer program that causes a computer (40) to execute:
a first step (52) of creating an operation plan for a hydrogen production facility (14) based on an amount of energy consumed by the hydrogen production facility (14) and a degradation loss of the hydrogen production facility (14); and
a second step (54) of outputting data including the operation plan created in the first step.

According to this computer program, it is possible to cause a computer to create an operation plan for a hydrogen production facility in which the economic loss due to facility deterioration is taken into consideration, and it is possible to improve the overall economic efficiency related to the operation of the hydrogen production facility.

### INDUSTRIAL APPLICABILITY

The technology of the present disclosure can be applied to an apparatus or a system that creates an operation plan of a hydrogen production facility.

### REFERENCE SIGNS LIST

10 hydrogen production system, 14 hydrogen production facility, 40 management server, 44 storage unit, 48 parameter acquisition unit, 50 demand prediction unit, 52 operation plan creation unit, 54 operation plan output unit, 100 power supply system, 102 solar panel, 104 power grid, 106 control device, 110 PCS, 114 hydrogen production facility, 116 hydrogen storage facility, 118 fuel cell, 120 storage battery

1. An information processing apparatus comprising a processor, wherein
the processor executes:
a first step of creating an operation plan for a hydrogen production facility based on an amount of energy consumed by the hydrogen production facility and a degradation loss of the hydrogen production facility; and
a second step of outputting data including the operation plan created in the first step.

2. The information processing apparatus according to claim 1, wherein
in the first step, processing using a mathematical programming on an objective function is executed to create an operation plan for the hydrogen production facility, and
the objective function includes a first term indicating a cost based on the amount of energy consumed by the hydrogen production facility and a second term indicating a cost based on the degradation loss of the hydrogen production facility.

3. The information processing apparatus according to claim 2, wherein
the first term indicates a cost based on the amount of energy consumed by the hydrogen production facility for each unit time, and
the second term indicates a cost based on the degradation loss of the hydrogen production facility for the each unit time.

4. The information processing apparatus according to claim 3, wherein
the second term includes a degradation acceleration rate determined according to a hydrogen production amount of the hydrogen production facility in the unit time.

5. The information processing apparatus according to claim 4, wherein
the degradation acceleration rate is configured to be relatively large when the hydrogen production amount of the hydrogen production facility in a certain unit time is relatively small, and to be relatively small when the hydrogen production amount of the hydrogen production facility in a certain unit time is relatively large.

6. The information processing apparatus according to claim 1, wherein
in the first step, an operation plan for each of a plurality of hydrogen production facilities is created based on an amount of energy consumed by each of the plurality of hydrogen production facilities and a degradation loss of each of the plurality of hydrogen production facilities.

7. A hydrogen production system comprising:
a hydrogen production facility; and
an information processing apparatus, wherein
the information processing apparatus executes:
a first step of creating an operation plan for the hydrogen production facility based on an amount of energy consumed by the hydrogen production facility and a degradation loss of the hydrogen production facility; and
a second step of outputting data including the operation plan created in the first step.

8. The hydrogen production system according to claim 7, further comprising
an instruction device structured to instruct the hydrogen production facility to produce hydrogen based on the data including the operation plan output from the information processing apparatus.

9. The hydrogen production system according to claim 8, wherein
the hydrogen production facility produces hydrogen based on an instruction from the instruction device.

10. A power supply system that supplies power to a power grid using power
obtained from a renewable energy power generator that generates power using
renewable energy, the power supply system comprising:
a power conditioner device structured to adjust power generated by the renewable energy power generator;
a storage battery capable of storing and discharging at least a part of surplus power that is not supplied to the power grid among power adjusted by the power conditioner device;
a hydrogen production facility structured to produce hydrogen by using at least a part of the surplus power that is not supplied to the power grid among the power adjusted by the power conditioner device;
a hydrogen storage facility capable of storing and releasing hydrogen produced by the hydrogen production facility;
a fuel cell structured to generate power using hydrogen released from the hydrogen storage facility; and
control means structured to control at least an operation of the hydrogen production facility, wherein
the control means creates an operation plan for the hydrogen production facility based on an amount of energy consumed by the hydrogen production facility and a degradation loss of the hydrogen production facility, and controls the hydrogen production facility based on the operation plan.

11. An operation plan creation method, wherein
a computer executes:
a first step of creating an operation plan for a hydrogen production facility based on an amount of energy consumed by the hydrogen production facility and a degradation loss of the hydrogen production facility; and
a second step of outputting data including the operation plan created in the first step.

12. A non-transitory computer-readable storage medium storing a computer program that causes a computer to execute:
a first step of creating an operation plan for a hydrogen production facility based on an amount of energy consumed by the hydrogen production facility and a degradation loss of the hydrogen production facility; and
a second step of outputting data including the operation plan created in the first step.
